(19) United States
(12) Patent Application Publication
(10) Pub. No.: US 2007/0068292 A1
(43) Pub. Date: Mar. 29, 2007

(54) Preload adjusting device for a ball screw

(75) Inventors: Chia-Min Liu, Taichung (TW); Chung-Hsuen Lin, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/230,271

(22) Filed: Sep. 19, 2005

(51) Int. Cl. F16H 25/22

(52) U.S. Cl. 74/89.42

(57) ABSTRACT

A preload adjusting device for a ball screw is disposed between screw nuts of a ball screw and comprises: two preload pieces each formed at a side thereof with a slant surface. The two preload pieces are mounted between the screw nuts in such a manner that the slant surfaces of the two preload pieces abut against each other, by such arrangements, a combined thickness of the two preload pieces will be changed by a relative displacement between the preload pieces, and in this way, a preload between the screw nuts is adjusted.

### BACKGROUND OF THE INVENTION

1. Field of the Invention

The present invention relates to a preload adjusting device, and more particularly to a preload adjusting device for a ball screw.

2. Description of the Prior Art

Ball screw, because of its high precision transmission performance, has found wide application in precision mechanism for controlling the horizontal or vertical displacement of the workbench. And in order to get rid of the back lash, the screw nut of the ball screw is often provided with a preload adjusting device for adjusting the preload thereof. As shown in FIGS. 1 and 2, two conventional preload adjusting devices for a ball screw are shown, wherein the distance between the screw nuts 10 and 11 and that between the screw nuts 12 and 13 are adjusted by threads 111 and a screw 14, respectively, and thus the preload of the ball screw is adjusted. However, these conventional preload adjusting devices are complicated in structure and are high cost in production, since the outer surface of the screw nut 11 has to be formed with the threads 111, and the screw nut 12 must be provided on its abutment surface thereof with a recess for installation of the screw 14.

The present invention has arisen to mitigate and/or obviate the afore-described disadvantages.

### SUMMARY OF THE INVENTION

The primary objective of the present invention is to provide a preload adjusting device for a ball screw comprising a pair of preload pieces, and an adjusting screw is used to adjust the displacement of the preload pieces, thus producing a desired preload. In this way, the preload of the ball screw can be adjusted easily without relying on the experience of the user.

One of the advantages of the present invention is that the preload is controlled by a radial pushing force that is needed during assembly of the ball screw, and thus the preload of the ball screw can be adjusted easily.

Another of the advantages of the present invention is simple structure, because the preload can be controlled either by the length of the protrusion of the fixing member or the thickness of the pad of the ball screw.

A preload adjusting device for a ball screw in accordance with the present invention is disposed between screw nuts of a ball screw and comprises:

two preload pieces each formed at a side thereof with a slant surface and mounted between the screw nuts in such a manner that the slant surfaces of the two preload pieces abut against each other, by such arrangements, a combined thickness of the two preload pieces will be changed by a relative displacement between the preload pieces, and in this way, a preload between the screw nuts is adjusted.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a cross sectional view of a conventional preload adjusting device for a ball screw;

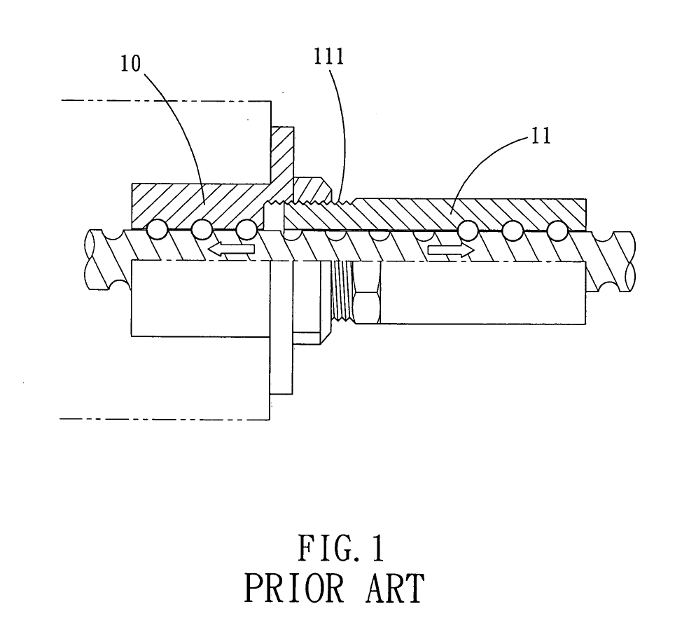

FIG. 2 is a cross sectional view of a part of another conventional preload adjusting device for a ball screw;

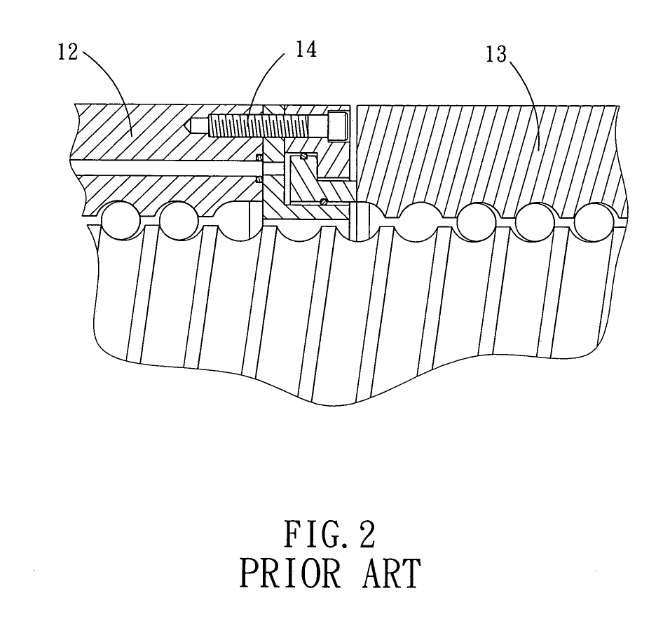

FIG. 3 is an exploded view of a preload adjusting device for a ball screw in accordance with the present invention;

FIG. 4 is a cross sectional view of the preload adjusting device for a ball screw in accordance with the present invention;

FIG. 5a is an illustrative view in accordance with the present invention of showing the preload pieces are abutting against each other;

FIG. 5b is an illustrative view in accordance with the present invention of showing the preload pieces are moving against each other;

FIG. 5c is an illustrative view in accordance with the present invention of illustrating the stress condition of one of the preload pieces.

### DETAILED DESCRIPTION OF THE PREFERRED EMBODIMENT

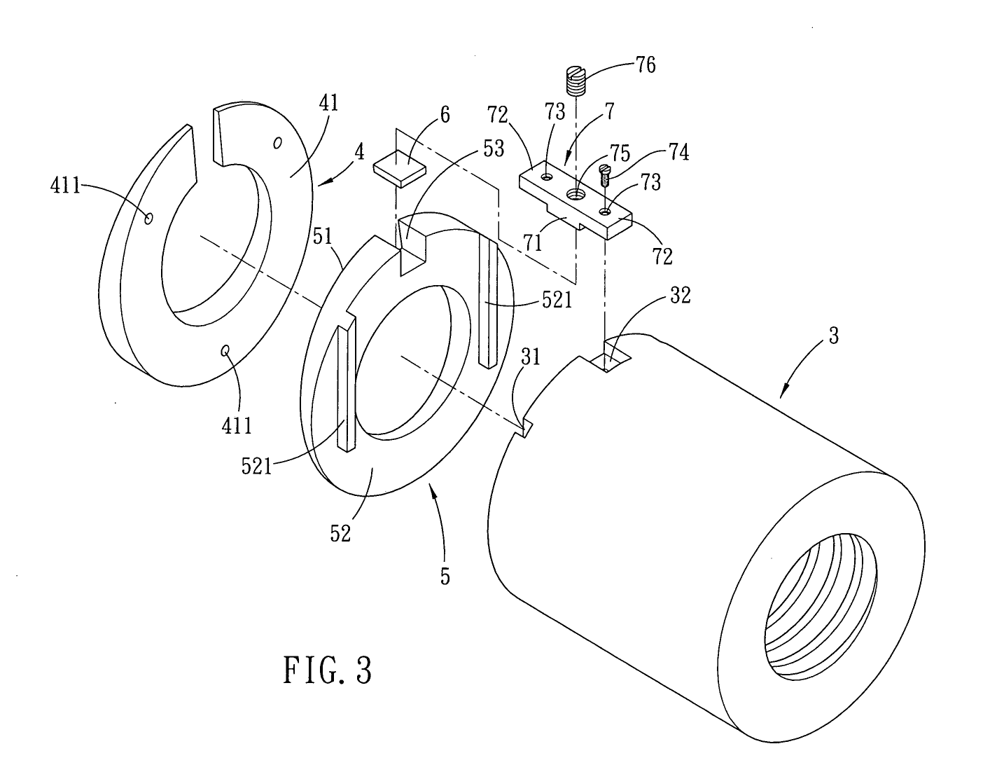

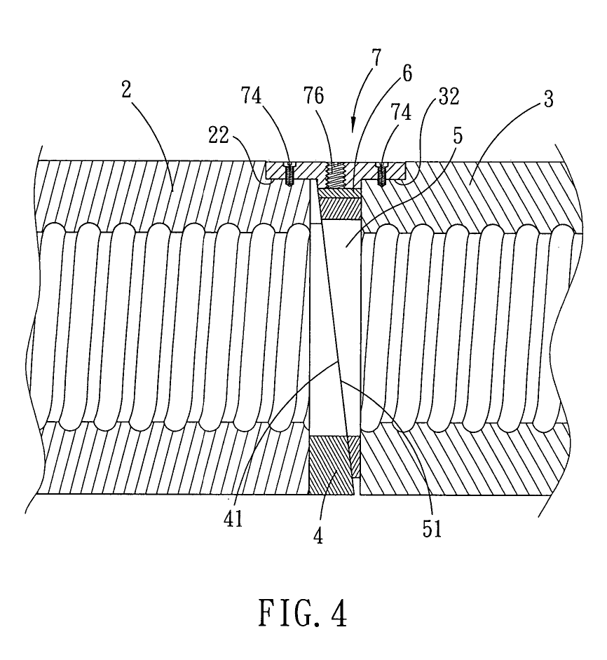

Referring to FIGS. 3 and 4, a preload adjusting device in accordance with the present invention is disposed between two screw nuts 2 and 3 for adjusting the preload of the ball screw and mainly comprises two preload pieces 4 and 5 each is formed at a side thereof with a slant surface 41 and 51. The preload pieces 4 and 5 are mounted between the two screw nuts 2 and 3 in such a manner that the slant surfaces 41 and 51 abut against each other. By such arrangements, the combined thickness of the preload pieces 4 and 5 can be changed by the relative displacement of the preload pieces 4 and 5, that is, the distance between the screw nuts 2 and 3 is also changed, and in this way, the preload of the ball screw is adjusted.

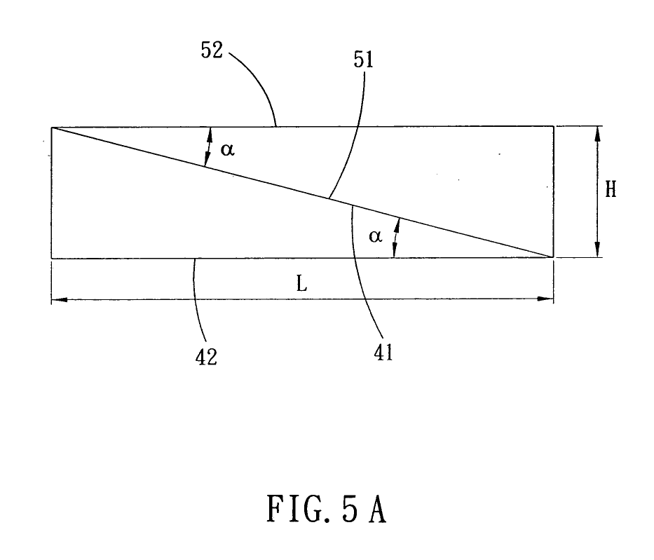

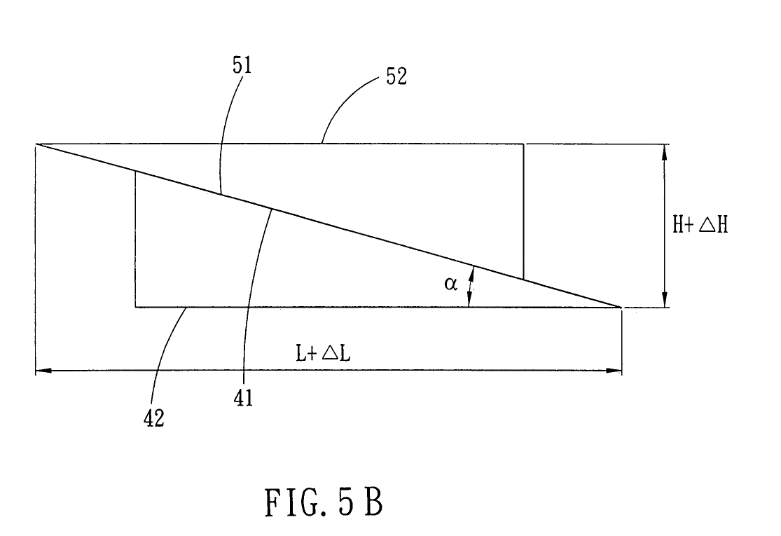

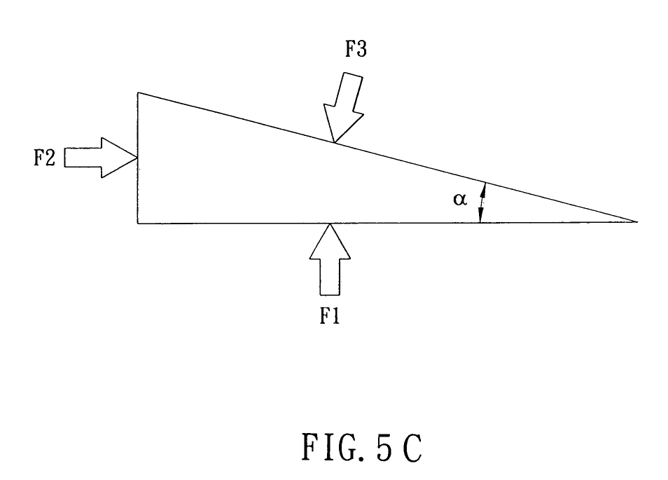

For a better understanding of the present invention, its operation and function, references should be made to FIGS. 4, 5a, 5b and 5c. Suppose that an angle of the slant surface 41 and 51 relative to another surface 42 and 52 of the preload pieces 4 and 5 is a, when the preload pieces 4 and 5 abut against and move relative to each other (as shown in FIG. 5a), and if the horizontal displacement between the two preload pieces 4 and 5 is ΔL, and then it will result in a vertical displacement ΔH (ΔH=ΔL x tan a) between the two preload pieces 4 and 5 (as shown in FIG. 5b), that is, the variation of the combined thickness of the two preload pieces 4 and 5 is ΔH. In this way, different preloads can be produced between the screw nuts 2 and 3. As shown in FIG. 5c, when a radial force F2 is applied during the assembly process, the force (namely, the preload of the ball screw) between the respective preload pieces 4, 5 and the abutment surfaces of the screw nuts 2 and 3 will be F1, and F3 represents the force between the slant surfaces 41 and 51 of the respective preload pieces 4 and 5.

As shown in FIG. 3, the preload adjusting device for a ball screw in accordance with the present invention comprises the two preload pieces 4 and 5, a pad 6, a fixing member 7 and an adjusting screw 76. The preload piece 5 is formed with a notch 53 for reception of the fixing member 7, and the preload piece 4 is defined with a plurality of holes 411 through which a plurality of pins (not shown) are inserted, so that the preload piece 4 is jointed to the screw nut 2. On the surface 52 of the screw nut 5 (opposite the slant surface 51) are formed a plurality of connecting ribs 521, and in the screw nut 3 are correspondingly formed a plurality of connecting grooves 31 for mating with the connecting ribs 521. By such arrangements, the preload piece 5 will slide automatically when it is subjected to a radial force. It will be noted that the pad 6 is disposed between the notch 53 of the preload piece 5 and the fixing member 7, and the number of the pad 6 can be varied according to needs, the greater the number of the pad 6, the greater the preload of the ball screw.

With references to FIGS. 3 and 4, the fixing member 7 is approximately T-shaped, so that the protrusion 71 of the fixing member 7 can be used to abut against the pad 6, and the shoulder portion 72 at either side of the protrusion 71 can be engaged in the locking recesses 22 and 32 of the screw nuts 2 and 3. In this way, the screw nuts 2 and 3 are jointed together. To connect the screw nuts 2 and 3 more firmly, the fixing member 7 is formed with a plurality of threaded holes 73 through which the fixing member 7 is jointed to the screw nuts 2 and 3 by a plurality of screws 74. Besides, in order to control the displacement of the preload piece 5, the fixing member 7 is further defined with an adjusting threaded hole 75 through which the adjusting screw 76 is screwed and serves to push the preload piece 5.

While we have shown and described various embodiments in accordance with the present invention, it should be clear to those skilled in the art that further embodiments may be made without departing from the scope of the present invention.

What is claimed is:

1. A preload adjusting device for a ball screw being disposed between screw nuts of a ball screw and comprising:
two preload pieces each formed at a side thereof with a slant surface and mounted between the screw nuts in such a manner that the slant surfaces of the two preload pieces abut against each other, by such arrangements, a combined thickness of the two preload pieces will be changed by a relative displacement between the preload pieces, and in this way, a preload between the screw nuts is adjusted.

2. The preload adjusting device for a ball screw as claimed in claim 1, wherein one of the preload pieces is formed with a notch for reception of a fixing member, and another one of the preload pieces is defined with a plurality of holes through which a plurality of pins are inserted and employed to joint the another one of the preload pieces to one of the screw nuts.

3. The preload adjusting device for a ball screw as claimed in claim 2, wherein a pad is disposed between the notch of the preload piece and the fixing member.

4. The preload adjusting device for a ball screw as claimed in claim 2, wherein a plurality of connecting ribs are formed on a surface of the preload piece opposite the slant surface, and in the screw nut are correspondingly formed a plurality of connecting grooves for mating with the connecting ribs, so that the preload piece will slide when it is subjected to a radial force.

5. The preload adjusting device for a ball screw as claimed in claim 2, wherein at least one pad is disposed between the notch of the preload piece and the fixing member.

6. The preload adjusting device for a ball screw as claimed in claim 2, wherein the fixing member is approximately T-shaped and serves to connect the screw nuts together.

7. The preload adjusting device for a ball screw as claimed in claim 2, wherein the fixing member is further defined with an adjusting threaded hole through which an adjusting screw is screwed and used to push the preload piece.

8. The preload adjusting device for a ball screw as claimed in claim 6, wherein the fixing member is formed with a plurality of threaded holes through which the fixing member is jointed to the screw nuts by a plurality of screws.
